(19) United States
(12) Patent Application Publication
(10) Pub. No.: US 2024/0301242 A1
(43) Pub. Date: Sep. 12, 2024

(54) MOLYBDENUM POLISHING COMPOSITIONS AND METHODS

(71) Applicant: FUJIMI INCORPORATED, Kiyosu-shi (JP)

(72) Inventor: Shogo Onishi, Tualatin, OR (US)

(21) Appl. No.: 18/593,021

(22) Filed: Mar. 1, 2024

Related U.S. Application Data
(60) Provisional application No. 63/449,831, filed on Mar. 3, 2023.

(51) Int. Cl. C09G 1/02

(52) U.S. Cl. CPC C09G 1/02

(57) ABSTRACT

Molybdenum polishing compositions and methods according to the present disclosure include abrasive particles, a first and a second oxidizers, and a first and a second molybdenum static etch rate suppressors, wherein the pH of the polishing composition is from 4 to 9. Compositions according to the present disclosure are effective to efficiently polish molybdenum at a high removal rate, which achieving a low molybdenum static etch rate, thereby obtaining a high Mo RR/SER ratio. Compositions and methods according to the present disclosure thus result in improved molybdenum polishing processes and higher-quality molybdenum surfaces than are achieved by conventional polishing compositions.

### CROSS-REFERENCE TO RELATED APPLICATIONS

This application claims the benefit of and priority to U.S. Provisional Application No. 63/449,831, filed on Mar. 3, 2023, which is incorporated by reference herein in its entirety.

### BACKGROUND

The following description of the background of the present technology is provided simply as an aid in understanding the present technology and is not admitted to describe or constitute prior art to the present technology.

Molybdenum metal is finding increased use in applications for microelectronic devices, including use in low-resistivity interconnects, particularly with nanoscale dimensions (e.g., thicknesses under 50 nm).

### SUMMARY

However, current compositions and methods for polishing molybdenum surfaces have been found to suffer from low removal rate or high static etch rate for polished molybdenum. Thus, it was determined to provide compositions and methods of polishing molybdenum surfaces that have a high removal rate while achieving a low static etch rate (SER) for molybdenum.

In one aspect, the present disclosure relates to a molybdenum polishing composition, comprising: an abrasive; a first molybdenum static etch rate suppressor; a second molybdenum static etch rate suppressor; a first oxidizer; and a second oxidizer, wherein the polishing composition has a pH of 4 to 9.

In some embodiments, the abrasive is present in the composition at a concentration of about 0.1 wt. % to about 3 wt. %, relative to the total weight of the composition. In some embodiments, the abrasive is present in the composition at a concentration of about 0.2 wt. % to about 1.5 wt. %, relative to the total weight of the composition.

In some embodiments, the abrasive comprises particles having an average primary particle diameter of about 10 nm to about 70 nm. In some embodiments, the abrasive comprises particles having an average primary particle diameter of about 10 nm to about 30 nm.

In some embodiments, the abrasive comprises colloidal silica. In some embodiments, the abrasive comprises unmodified colloidal silica.

In some embodiments, the first molybdenum static etch rate suppressor is present at a concentration of about 0.001 wt. % to about 1 wt. %, relative to the total weight of the composition. In some embodiments, the first molybdenum static etch rate suppressor is present at a concentration of about 0.01 wt. % to about 0.1 wt. %, relative to the total weight of the composition.

In some embodiments, the first molybdenum static etch rate suppressor comprises an anionic surfactant having a sulfonic acid moiety, phosphoric acid moiety, or a salt thereof. In some embodiments, the first molybdenum static etch rate suppressor comprises at least one selected from: dodecyl(sulfonatophenoxy)benzenesulfonic acid or salts thereof (e.g., disodium dodecyl(sulfonatophenoxy)benzenesulfonate (CAS No. 28519-02-0)); sulfonated benzene, 1,1′-oxybis-, sec-hexyl derivatives (CAS No. 147732-59-0); sulfonated benzene, 1,1′-oxybis-, tetrapropylene derivatives (CAS No. 119345-03-8); polyoxyethylene (10) oleyl ether phosphate; polyoxyethylene (8) phenyl phosphate; polyoxyethylene (14) oleyl ether phosphate; polyoxyethylene (10) alkyl ether phosphate; polyoxyethylene (8) tridecyl ether phosphate; polyoxyethylene (10) tridecyl ether phosphate; polyoxyethylene (12) tridecyl ether phosphate; and salts thereof. In some embodiments, the first molybdenum static etch rate suppressor comprises at least one selected from the group consisting of: dodecyl(sulfonatophenoxy)benzenesulfonic acid or salts thereof (e.g., disodium dodecyl(sulfonatophenoxy)benzenesulfonate (CAS No. 28519-02-0)); sulfonated benzene, 1,1′-oxybis-, sec-hexyl derivatives (CAS No. 147732-59-0); sulfonated benzene, 1,1′-oxybis-, tetrapropylene derivatives (CAS No. 119345-03-8); and salts thereof. In some embodiments, the first molybdenum static etch rate suppressor comprises dodecyl-(sulfonatophenoxy)benzenesulfonic acid or a salt thereof. In some embodiments, the first molybdenum static etch rate suppressor comprises disodium dodecyl-(sulfonatophenoxy)benzenesulfonate (CAS No. 28519-02-0)).

In some embodiments, the second molybdenum static etch rate suppressor is present at a concentration of about 0.005 wt. % to about 1.0 wt. %, relative to the total weight of the composition. In some embodiments, the second molybdenum static etch rate suppressor is present at a concentration of about 0.01 wt. % to about 0.7 wt. %, relative to the total weight of the composition.

In some embodiments, the second molybdenum static etch rate suppressor comprises a basic amino acid. In some embodiments, the second molybdenum static etch rate suppressor is at least one selected from the group consisting of: arginine, histidine, and lysine. In some embodiments, the second molybdenum static etch rate suppressor comprises arginine.

In some embodiments, the first oxidizer is present in the composition at a concentration of about 0.01 wt. % to about 1.0 wt. %, relative to the total weight of the composition. In some embodiments, the first oxidizer is present in the composition at a concentration of about 0.05 wt. % to about 0.7 wt. %, relative to the total weight of the composition.

In some embodiments, the first oxidizer comprises potassium iodate. In some embodiments, the second oxidizer comprises hydrogen peroxide.

In some embodiments, the second oxidizer is present in the composition at a concentration of about 0.01 wt. % to about 5.0 wt. %, relative to the total weight of the composition. In some embodiments, the second oxidizer is present in the composition at a concentration of about 0.5 wt. % to about 1.5 wt. %, relative to the total weight of the composition.

In some embodiments, the polishing composition comprises a pH adjuster. In some embodiments, the pH adjuster is KOH. In some embodiments, the pH of the composition is from 5 to 7.

In some embodiments, the composition is effective to obtain a molybdenum removal rate of at least about 300 Å/min. In some embodiments, the composition is effective to obtain a molybdenum removal rate of at least about 500 Å/min. In some embodiments, the composition is effective to obtain a molybdenum removal rate of at least about 700 Å/min.

In some embodiments, the composition is effective to obtain a molybdenum static etch rate of 100 Å/min or less. In some embodiments, the composition is effective to obtain a molybdenum static etch rate of 70 Å/min or less.

In some embodiments, the composition is effective to obtain a ratio of molybdenum removal rate to molybdenum static etch rate of at least about 5. In some embodiments, composition is effective to obtain a ratio of molybdenum removal rate to molybdenum static etch rate of at least about 8. In some embodiments, the composition is effective to obtain a ratio of molybdenum removal rate to molybdenum static etch rate of at least about 10.

In another aspect, which may be combined with any other aspect or embodiment, the present disclosure relates to a polishing method, comprising: contacting a molybdenum surface with the polishing composition according to the present disclosure; and removing molybdenum from the molybdenum surface at a removal rate of at least about 300 A/min to produce a polished molybdenum surface. In some embodiments, the removal rate is at least about 500 Å/min. In some embodiments, the removal rate is at least about 700 Å/min.

The present invention also encompasses the following aspects and forms.
1. A molybdenum polishing composition comprising: an abrasive; a first molybdenum static etch rate suppressor; a second molybdenum static etch rate suppressor; a first oxidizer; and a second oxidizer, wherein the molybdenum polishing composition has a pH of 4 to 9.
2. The composition of 1., wherein the abrasive comprises unmodified colloidal silica.
3. The composition of 1. or 2., wherein the first molybdenum static etch rate suppressor comprises an anionic surfactant having a sulfonic acid moiety (—SO₃), phosphoric acid moiety (—OPO₃), or a salt thereof.
4. The composition of any of 1. to 3., wherein the first molybdenum static etch rate suppressor has a diphenyl ether structure.
5. The composition of any of 1. to 4., wherein the first molybdenum static etch rate suppressor has two or more sulfonic acid moieties (—SO₃).
6. The composition of any of 1. to 5., wherein the first molybdenum static etch rate suppressor has an oxyalkylene structure and a phosphoric acid moiety (—OPO₃).
7. The composition of any of 1. to 6., wherein the first molybdenum static etch rate suppressor comprises at least one selected from: dodecyl(sulfonatophenoxy)benzenesulfonic acid or salts thereof; benzene, 1,1′-oxybis-, sec-hexyl derivatives, sulfonated (acid type) or salts thereof; benzene, 1,1′-oxybis-, tetrapropylene derivatives, sulfonated (acid type) or salts thereof; polyoxyethylene (10) oleyl ether phosphate; polyoxyethylene (8) phenyl phosphate; polyoxyethylene (14) oleyl ether phosphate; polyoxyethylene (10) alkyl ether phosphate; polyoxyethylene (8) tridecyl ether phosphate; polyoxyethylene (10) tridecyl ether phosphate; polyoxyethylene (12) tridecyl ether phosphate; and salts thereof.
8. The composition of any of 1. to 7., wherein the second molybdenum static etch rate suppressor comprises an amino acid.
9. The composition of any of 1. to 8., wherein the second molybdenum static etch rate suppressor comprises a basic amino acid.
10. The composition of any of 1. to 9., wherein the first molybdenum static etch rate suppressor has a diphenyl ether structure and the second molybdenum static etch rate suppressor comprises a basic amino acid.
11. The composition of any of 1. to 10., wherein the first oxidizer comprises a halogen atom.
12. The composition of any of 1. to 11., wherein the first oxidizer comprises potassium iodate.
13. The composition of any of 1. to 12., wherein the second oxidizer comprises hydrogen peroxide.
14. The composition of any of 1. to 13., wherein a silanol group density of the abrasive is 2.0/nm² or more.
15. The composition of any of 1. to 14., wherein the abrasive comprises unmodified colloidal silica, the abrasive has the silanol group density of 2.0/nm² or more, the first molybdenum static etch rate suppressor has, in one molecule, a diphenyl ether structure and one or more sulfonic acid moieties (—SO₃) or an oxyalkylene structure and a phosphoric acid moiety (—OPO₃), the second molybdenum static etch rate suppressor comprises a basic amino acid, the first oxidizer comprises potassium iodate, and the second oxidizer comprises hydrogen peroxide.
16. The composition of any of 1. to 15., wherein the total concentration of the first molybdenum static etch rate suppressor and the second molybdenum static etch rate suppressor is about 0.03 wt. % to about 1.0 wt. %.
17. The composition of any of 1. to 16., wherein the composition has a ratio of molybdenum removal rate to molybdenum static etch rate greater than 6.0.

Reference will now be made in detail to some specific embodiments contemplated by the present disclosure. While various embodiments are described herein, it will be understood that it is not intended to limit the present technology to the described embodiments. On the contrary, it is intended to cover alternatives, modifications, and equivalents as may be included within the spirit and scope of the technology as defined by the appended claims.

Herein, “X to Y” is used to mean that numerical values (X and Y) described before and after “to” are included as a lower limit value and an upper limit value, and means “X or more and Y or less”. In a case where a plurality of “X to Y” are described, for example, in a case where “X1 to Y1, or X2 to Y2” is described, a disclosure in which each numerical value is an upper limit, a disclosure in which each numerical value is a lower limit, and a combination of the upper limit and the lower limit are all disclosed (that is, it is a legitimate basis for the amendment.). Specifically, all of the correction of X1 or more, the correction of Y2 or less, the correction of X1 or less, the correction of Y2 or more, the correction of X1 to X2, the correction of X1 to Y2, and the like must be regarded as legitimate. In addition, unless otherwise specified, operations and measurements of physical properties and the like are performed under the conditions of room temperature (20 to 25° C.)/relative humidity 40 to 50% RH. The concentration described herein may be a concentration in POU (point of use) or a concentration before dilution to the concentration of POU. The dilution fold may be 2 to 10 folds.

### BRIEF DESCRIPTION OF THE FIGURES

The accompanying drawings, which are incorporated in and constitute a part of this specification, illustrate several embodiments that, together with the description, serve to explain the principles and features of the present disclosure.

FIG. 1 illustrates the effect of oxidizer combination on Mo removal rate and static etch rate.

FIG. 2 illustrates polishing performance of two-oxidizer compositions including Mo static etch rate suppressor.

### DETAILED DESCRIPTION

The present disclosure relates to compositions and methods of polishing molybdenum surfaces which achieve a high Mo removal rate (RR) and a low Mo static etch rate (SER). In one aspect, the present disclosure relates to a molybdenum polishing composition, comprising: an abrasive; one or more Mo static etch rate suppressors; and one or more oxidizers.

### Abrasive

The abrasive is composed of a plurality of abrasive particles.

Polishing compositions according to the present disclosure comprise abrasive particles suitable for polishing a surface comprising molybdenum (Mo). In some embodiments, the abrasive particles comprise one or more metal oxide particles, e.g., zirconia, hafnia, alumina, titania, silica, ceria, and any combination thereof. In some embodiments, the abrasive particles comprise colloidal silica. In addition, the abrasive particles may be a commercial product, synthetic product, or any combination thereof. In some embodiments, the abrasive particles are anionic. Within the context of this application, “anionic” particles have a negative surface charge or zeta potential charge at the pH of the polishing composition. In some embodiments, the abrasive particles are cationic. Within the context of this application, “cationic” particles have a positive surface charge or zeta potential charge at the pH of the polishing composition.

In some embodiments, the abrasive does not comprise at least one selected from the group consisting of zirconia, hafnia, alumina, titania, and ceria.

In some embodiments, the abrasive particles are unmodified (i.e., do not have a chemical species attached to the particle surface). The surface potential of molybdenum as an object to be polished is negative under an environment with a pH of around 4 to 9. Here, for example, when anionically modified (for example, sulfonic acid-modified) colloidal silica is used as abrasive particles, the surface potential of the silica is negative in the pH range. Therefore, the electrical repulsion between the abrasive particles and the object to be polished increases, and the abrasive particles hardly come into contact with the object to be polished, and as a result, the polishing speed decreases. On the other hand, the surface potential of the unmodified abrasive particles (typically, unmodified colloidal silica) changes in a positive direction as the pH is changed from 7 to acidic, and becomes 0 (isoelectric point) when the pH is around 2 to 3. In a pH ranging from 7 to 9, the surface potential of the unmodified abrasive particles (typically, unmodified colloidal silica) is negative. That is, when the pH of the polishing composition is adjusted to an appropriate range of 4 to 9 and unmodified abrasive particles (typically, unmodified colloidal silica) are used, the electrical relationship between the abrasive particles and the object to be polished can be made appropriate. Therefore, the object to be polished is efficiently polished. In addition, a technical effect of improving the stability of the polishing composition is also associated. In some embodiments, the abrasive (abrasive particles) comprises unmodified colloidal silica. In some embodiments, the abrasive particles are surface-modified by a chemical species covalently attached to the particle surface and having a terminal anionic group or cationic group. In some embodiments, the abrasive particles comprise colloidal particles which are anionically modified, e.g., by immobilization of an organic acid on the colloidal particle surface. In some embodiments, greater than or equal to 80 wt. %, greater than or equal to 85 wt. %, greater than or equal to 90 wt. %, greater than or equal to 95 wt. %, greater than or equal to 98 wt. %, or greater than or equal to 99 wt. % of the abrasive included in the composition is colloidal silica (in particular, unmodified colloidal silica).

In some embodiments, immobilization of an organic acid on the surface of the abrasive particles (e.g., colloidal silica) in the polishing composition may be carried out by chemically bonding a functional group of the organic acid to the surface of the abrasive particle (e.g., colloidal silica). The immobilization of an organic acid on colloidal silica cannot be achieved by only allowing colloidal silica and an organic acid to merely coexist. The immobilization of an organic acid (e.g., a sulfonic acid), on colloidal silica can be carried out, for example, by a method described in E. Cano-Serrano et al., Sulfonic Acid-Functionalized Silica Through Quantitative Oxidation of Thiol Groups, Chem. Commun. 246-47 (2003), which is hereby incorporated by reference in its entirety. Specifically, colloidal silica with a sulfonic acid immobilized on its surface can be obtained by coupling a silane coupling agent having a thiol group, such as 3-mercaptopropyl trimethoxysilane (“MPS”), to colloidal silica, followed by oxidizing the thiol group with hydrogen peroxide to form a surface-immobilized sulfonic acid (e.g., a surface-bound propane sulfonic acid, such as oxidized MPS).

The immobilization of a carboxylic acid on colloidal silica can be carried out, for example, by a method described in Y. Kazuo et al., Novel Silane Coupling Agents Containing a Photolabile 2-Nitrobenzyl Ester for Introduction of a Carboxy Group on the Surface of Silica Gel, 3 Chem. Lett. 228-29 (2000), which is hereby incorporated by reference in its entirety. Specifically, colloidal silica in which a carboxylic acid is immobilized on its surface can be obtained by coupling a silane coupling agent including photoreactive 2-nitrobenzyl ester to colloidal silica, followed by photoirradiation. These examples of organic acid immobilization on colloidal silica are intended to be exemplary and are not intended to be limiting. Other organic immobilization techniques using different organic acids and different abrasive particle materials (e.g., other than colloidal silica) are intended to be encompassed within the scope of the present disclosure.

The abrasive particles may have any suitable average primary particle diameter to achieve efficient polishing (high removal rate) while achieving a high-quality surface (e.g., reduced surface defects, such as scratches). In some embodiments, the abrasive particles have an average primary particle diameter of greater than or equal to about 5 nm, greater than or equal to about 6 nm, greater than or equal to about 7 nm, greater than or equal to about 8 nm, greater than or equal to about 9 nm, greater than or equal to about 10 nm, greater than or equal to about 11 nm, greater than or equal to about 12 nm, greater than or equal to about 13 nm, greater than or equal to about 14 nm, greater than or equal to about 15 nm, greater than or equal to about 16 nm, greater than or equal to about 17 nm, greater than or equal to about 18 nm, greater than or equal to about 19 nm, greater than or equal to about 20 nm, greater than or equal to about 21 nm, greater than or equal to about 22 nm, greater than or equal to about 23 nm, greater than or equal to about 24 nm, greater than or equal to about 25 nm, greater than or equal to about 30 nm, greater than or equal to about 35 nm, greater than or equal to about 40 nm, greater than or equal to about 45 nm, greater than or equal to about 50 nm, greater than or equal to about 55 nm, greater than or equal to about 60 nm, greater than or equal to about 65 nm, greater than or equal to about 70 nm, greater than or equal to about 75 nm, greater than or equal to about 80 nm, greater than or equal to about 85 nm, greater than or equal to about 90 nm, greater than or equal to about 95 nm, greater than or equal to about 100 nm, greater than or equal to about 110 nm, greater than or equal to about 120 nm, greater than or equal to about 130 nm, greater than or equal to about 140 nm, greater than or equal to about 150 nm, or any range or value therein between. The average primary particle diameter may be measured using any suitable method known in the art (e.g., transmission electron microscopy, scanning electron microscopy, or by STEM, such as by using a Hitachi High-Tech HD-2700 Scanning Transmission Electron Microscope).

Herein, about X (X is a numerical value) means that it further includes ±10% or ±5% of X, and specifically means X×0.9 to X×1.1. Further, about X may be X itself.

In some embodiments, the abrasive particles have an average primary particle diameter of less than or equal to about 150 nm, less than or equal to about 140 nm, less than or equal to about 130 nm, less than or equal to about 120 nm, less than or equal to about 110 nm, less than or equal to about 100 nm, less than or equal to about 95 nm, less than or equal to about 90 nm, less than or equal to about 85 nm, less than or equal to about 80 nm, less than or equal to about 75 nm, less than or equal to about 70 nm, less than or equal to about 65 nm, less than or equal to about 60 nm, less than or equal to about 55 nm, less than or equal to about 50 nm, less than or equal to about 45 nm, less than or equal to about 40 nm, less than or equal to about 35 nm, less than or equal to about 30 nm, less than or equal to about 25 nm, less than or equal to about 24 nm, less than or equal to about 23 nm, less than or equal to about 22 nm, less than or equal to about 21 nm, less than or equal to about 20 nm, less than or equal to about 19 nm, less than or equal to about 18 nm, less than or equal to about 17 nm, less than or equal to about 16 nm, less than or equal to about 15 nm, less than or equal to about 14 nm, less than or equal to about 13 nm, less than or equal to about 12 nm, less than or equal to about 11 nm, less than or equal to about 10 nm, less than or equal to about 9 nm, less than or equal to about 8 nm, less than or equal to about 7 nm, or any range or value therein between.

In some embodiments, the abrasive particles have an average primary particle diameter of about 5 nm to about 150 nm, about 5 nm to about 100 nm, about 5 nm to about 90 nm, about 5 nm to about 80 nm, about 5 nm to about 70 nm, about 5 nm to about 60 nm, about 5 nm to about 50 nm, about 5 nm to about 45 nm, about 5 nm to about 40 nm, about 5 nm to about 35 nm, about 5 nm to about 30 nm, about 5 nm to about 25 nm, about 10 nm to about 150 nm, about 10 nm to about 100 nm, about 10 nm to about 90 nm, about 10 nm to about 80 nm, about 10 nm to about 70 nm, about 10 nm to about 60 nm, about 10 nm to about 50 nm, about 10 nm to about 45 nm, about 10 nm to about 40 nm, about 10 nm to about 35 nm, about 10 nm to about 30 nm, about 10 nm to about 25 nm, about 10 nm to about 20 nm, about 10 nm to about 15 nm, about 20 nm to about 150 nm, about 20 nm to about 100 nm, about 20 nm to about 90 nm, about 20 nm to about 80 nm, about 20 nm to about 70 nm, about 20 nm to about 60 nm, about 20 nm to about 50 nm, about 20 nm to about 45 nm, about 20 nm to about 40 nm, or any range or value therein. In some embodiments, the abrasive particles have an average primary particle diameter of about 14 nm to about 31 nm, or any range or value therein. In some embodiments, the abrasive particles have an average primary particle diameter of about 24 nm to about 40 nm, or any range or value therein.

In some embodiments, the abrasive particles have a mean particle diameter of greater than or equal to about 10 nm, greater than or equal to about 15 nm, greater than or equal to about 16 nm, greater than or equal to about 17 nm, greater than or equal to about 18 nm, greater than or equal to about 19 nm, greater than or equal to about 20 nm, greater than or equal to about 21 nm, greater than or equal to about 22 nm, greater than or equal to about 23 nm, greater than or equal to about 24 nm, greater than or equal to about 25 nm, greater than or equal to about 30 nm, greater than or equal to about 35 nm, greater than or equal to about 40 nm, greater than or equal to about 45 nm, greater than or equal to about 50 nm, greater than or equal to about 55 nm, greater than or equal to about 60 nm, greater than or equal to about 65 nm, greater than or equal to about 70 nm, greater than or equal to about 75 nm, greater than or equal to about 80 nm, greater than or equal to about 85 nm, greater than or equal to about 90 nm, greater than or equal to about 95 nm, greater than or equal to about 100 nm, greater than or equal to about 110 nm, greater than or equal to about 120 nm, greater than or equal to about 125 nm, greater than or equal to about 130 nm, greater than or equal to about 135 nm, greater than or equal to about 140 nm, greater than or equal to about 150 nm, or any range or value therein between. The mean particle diameter may be measured using any suitable method known in the art (e.g., by light scattering, such as by using a Malvern Panalytical ZetaSizer Nano light scattering system).

In some embodiments, the abrasive particles have a mean particle diameter of less than or equal to about 150 nm, less than or equal to about 140 nm, less than or equal to about 135 nm, less than or equal to about 130 nm, less than or equal to about 120 nm, less than or equal to about 110 nm, less than or equal to about 100 nm, less than or equal to about 95 nm, less than or equal to about 90 nm, less than or equal to about 85 nm, less than or equal to about 80 nm, less than or equal to about 75 nm, less than or equal to about 70 nm, less than or equal to about 65 nm, less than or equal to about 60 nm, less than or equal to about 55 nm, less than or equal to about 50 nm, less than or equal to about 45 nm, less than or equal to about 40 nm, less than or equal to about 35 nm, less than or equal to about 30 nm, less than or equal to about 25 nm, less than or equal to about 24 nm, less than or equal to about 23 nm, less than or equal to about 22 nm, less than or equal to about 21 nm, less than or equal to about 20 nm, or any range or value therein between.

In some embodiments, the abrasive particles have a mean particle diameter of about 10 nm to about 150 nm, about 10 nm to about 135 nm, about 10 nm to about 100 nm, about 10 nm to about 90 nm, about 10 nm to about 80 nm, about 10 nm to about 70 nm, about 10 nm to about 60 nm, about 10 nm to about 50 nm, about 10 nm to about 45 nm, about 10 nm to about 40 nm, about 10 nm to about 35 nm, about 10 nm to about 30 nm, about 10 nm to about 25 nm, about 10 nm to about 24 nm, about 10 nm to about 23 nm, about 10 nm to about 22 nm, about 10 nm to about 21 nm, about 10 nm to about 20 nm, about 20 nm to about 150 nm, about 20 nm to about 135 nm, about 20 nm to about 100 nm, about 20 nm to about 90 nm, about 20 nm to about 80 nm, about 20 nm to about 70 nm, about 20 nm to about 60 nm, about 20 nm to about 50 nm, about 20 nm to about 45 nm, about 20 nm to about 40 nm, about 20 nm to about 35 nm, about 20 nm to about 30 nm, about 20 nm to about 25 nm, or any range or value therein. In some embodiments, the abrasive particles have a mean particle diameter of about 24 nm to about 64 nm, or any range or value therein. In some embodiments, the abrasive particles have a mean particle diameter of about 45 nm to about 100 nm, or any range or value therein.

In some embodiments, the abrasive particles are present in the composition at a concentration by weight, relative to the total weight of the composition, of greater than or equal to about 0.01 wt. %, greater than or equal to about 0.05 wt. %, greater than or equal to about 0.1 wt. %, greater than or equal to about 0.15 wt. %, greater than or equal to about 0.2 wt. %, greater than or equal to about 0.25 wt. %, greater than or equal to about 0.3 wt. %, greater than or equal to about 0.35 wt. %, greater than or equal to about 0.4 wt. %, greater than or equal to about 0.45 wt. %, greater than or equal to about 0.5 wt. %, greater than or equal to about 0.55 wt. %, greater than or equal to about 0.60 wt. %, greater than or equal to about 0.65 wt. %, greater than or equal to about 0.7 wt. %, greater than or equal to about 0.75 wt. %, greater than or equal to about 0.8 wt. %, greater than or equal to about 0.85 wt. %, greater than or equal to about 0.9 wt. %, greater than or equal to about 0.95 wt. %, greater than or equal to about 1.0 wt. %, greater than or equal to about 1.1 wt. %, greater than or equal to about 1.2 wt. %, greater than or equal to about 1.3 wt. %, greater than or equal to about 1.4 wt. %, greater than or equal to about 1.5 wt. %, greater than or equal to about 1.6 wt. %, greater than or equal to about 1.7 wt. %, greater than or equal to about 1.8 wt. %, greater than or equal to about 1.9 wt. %, greater than or equal to about 2.0 wt. %, greater than or equal to about 2.5 wt. %, greater than or equal to about 3.0 wt. %, greater than or equal to about 3.5 wt. %, greater than or equal to about 4.0 wt. %, greater than or equal to about 4.5 wt. %, greater than or equal to about 5.0 wt. %, greater than or equal to about 5.5 wt. %, greater than or equal to about 6.0 wt. %, greater than or equal to about 6.5 wt. %, greater than or equal to about 7.0 wt. %, greater than or equal to about 7.5 wt. %, greater than or equal to about 8.0 wt. %, greater than or equal to about 8.5 wt. %, greater than or equal to about 9.0 wt. %, greater than or equal to about 9.5 wt. %, greater than or equal to about 10.0 wt. %, or any range or value therein between. In some embodiments, the abrasive particles are present in the composition at a concentration by weight, relative to the total weight of the composition, of greater than 0.2 wt. %.

In some embodiments, the abrasive particles are present in the composition at a concentration by weight, relative to the total weight of the composition, of less than or equal to about 10.0 wt. %, less than or equal to about 9.5 wt. %, less than or equal to about 9.0 wt. %, less than or equal to about 8.5 wt. %, less than or equal to about 8.0 wt. %, less than or equal to about 7.5 wt. %, less than or equal to about 7.0 wt. %, less than or equal to about 6.5 wt. %, less than or equal to about 6.0 wt. %, less than or equal to about 5.5 wt. %, less than or equal to about 5.0 wt. %, less than or equal to about 4.5 wt. %, less than or equal to about 4.0 wt. %, less than or equal to about 3.5 wt. %, less than or equal to about 3.0 wt. %, less than or equal to about 2.5 wt. %, less than or equal to about 2.0 wt. %, less than or equal to about 1.9 wt. %, less than or equal to about 1.8 wt. %, less than or equal to about 1.7 wt. %, less than or equal to about 1.6 wt. %, less than or equal to about 1.5 wt. %, less than or equal to about 1.4 wt. %, less than or equal to about 1.3 wt. %, less than or equal to about 1.2 wt. %, less than or equal to about 1.1 wt. %, less than or equal to about 1.0 wt. %, less than or equal to about 0.95 wt. %, less than or equal to about 0.9 wt. %, less than or equal to about 0.85 wt. %, less than or equal to about 0.8 wt. %, less than or equal to about 0.75 wt. %, less than or equal to about 0.7 wt. %, less than or equal to about 0.65 wt. %, less than or equal to about 0.6 wt. %, less than or equal to about 0.55 wt. %, less than or equal to about 0.5 wt. %, less than or equal to about 0.45 wt. %, less than or equal to about 0.4 wt. %, less than or equal to about 0.35 wt. %, less than or equal to about 0.3 wt. %, less than or equal to about 0.25 wt. %, less than or equal to about 0.2 wt. %, less than or equal to about 0.15 wt. %, less than or equal to about 0.1 wt. %, or any range or value therein between.

In some embodiments, the abrasive particles are present in the composition at a concentration by weight, relative to the total weight of the composition, of about 0.1 wt. % to about 10.0 wt. %, about 0.2 wt. % to about 10.0 wt. %, about 0.3 wt. % to about 10.0 wt. %, about 0.4 wt. % to about 10.0 wt. %, about 0.5 wt. % to about 10.0 wt. %, about 0.6 wt. % to about 10.0 wt. %, about 0.7 wt. % to about 10.0 wt. %, about 0.8 wt. % to about 10.0 wt. %, about 0.9 wt. % to about 10.0 wt. %, about 1.0 wt. % to about 10.0 wt. %, about 2 wt. % to about 10.0 wt. %, about 3 wt. % to about 10.0 wt. %, about 4 wt. % to about 10.0 wt. %, about 5 wt. % to about 10.0 wt. %, about 0.1 wt. % to about 5 wt. %, about 0.2 wt. % to about 5 wt. %, about 0.3 wt. % to about 5 wt. %, about 0.4 wt. % to about 5 wt. %, about 0.5 wt. % to about 5 wt. %, about 0.6 wt. % to about 5 wt. %, about 0.7 wt. % to about 5 wt. %, about 0.8 wt. % to about 5 wt. %, about 0.9 wt. % to about 5 wt. %, about 1.0 wt. % to about 5 wt. %, about 0.1 wt. % to about 3.0 wt. %, about 0.1 wt. % to about 2.5 wt. %, about 0.1 wt. % to about 2.0 wt. %, about 0.1 wt. % to about 1.5 wt. %, about 0.1 wt. % to about 1.0 wt. %, about 0.2 wt. % to about 3.0 wt. %, about 0.2 wt. % to about 2.5 wt. %, about 0.2 wt. % to about 2.0 wt. %, about 0.2 wt. % to about 1.5 wt. %, about 0.2 wt. % to about 1.0 wt. %, about 0.3 wt. % to about 2.0 wt. %, about 0.4 wt. % to about 2.0 wt. %, about 0.5 wt. % to about 2.0 wt. %, about 0.6 wt. % to about 2.0 wt. %, about 0.7 wt. % to about 2.0 wt. %, about 0.8 wt. % to about 2.0 wt. %, about 0.9 wt. % to about 2.0 wt. %, about 1.0 wt. % to about 2.0 wt. %, about 0.1 wt. % to about 1.0 wt. %, about 0.2 wt. % to about 1.0 wt. %, about 0.5 wt. % to about 3.0 wt. %, about 0.5 wt. % to about 2.5 wt. %, about 0.5 wt. % to about 2.0 wt. %, about 0.5 wt. % to about 1.5 wt. %, about 0.5 wt. % to about 1.0 wt. %, about 1.0 wt. % to about 5.0 wt. %, about 1.0 wt. % to about 4.0 wt. %, about 1.0 wt. % to about 3.0 wt. %, about 1.0 wt. % to about 2.5 wt. %, about 1.0 wt. % to about 2.0 wt. %, or about 1.0 wt. % to about 1.5 wt. %, or any range or value therein between. In some embodiments, the abrasive particles are present in the composition at a concentration by weight, relative to the total weight of the composition, of about 0.01 wt. % to about 10.0 wt. %, or any range or value therein between. In some embodiments, the abrasive particles are present in the composition at a concentration by weight, relative to the total weight of the composition, of about 0.25 wt. % to about 5 wt. %, or any range or value therein between.

In some embodiments, the abrasive particles comprise silica (e.g., are colloidal silica particles). The number of silanol groups per unit surface area of the abrasive (for example, silica particles) (hereinafter, also referred to as a “density of a silanol group” or “silanol group density”) is not particularly limited. In some embodiments, the silica particles have a silanol group density of greater than or equal to 0/nm², greater than or equal to 1/nm², greater than or equal to 1.1/nm², greater than or equal to 1.2/nm², greater than or equal to 1.3/nm², greater than or equal to 1.4/nm², greater than or equal to 1.5/nm², greater than or equal to 1.6/nm², greater than or equal to 1.7/nm², greater than or equal to 1.8/nm², greater than or equal to 1.9/nm², greater than or equal to 2/nm², greater than or equal to 2.1/nm², greater than or equal to 2.2/nm², greater than or equal to 2.3/nm², greater than or equal to 2.4/nm², greater than or equal to 2.5/nm², greater than or equal to 3.0/nm², greater than or equal to 3.5/nm², greater than or equal to 4.0/nm², greater than or equal to 4.5/nm², greater than or equal to 5.0/nm², greater than or equal to 5.1/nm², greater than or equal to 5.2/nm², greater than or equal to 5.3/nm², greater than or equal to 5.4/nm², greater than or equal to 5.5/nm², greater than or equal to 5.6/nm², greater than or equal to 5.7/nm², greater than or equal to 5.8/nm², greater than or equal to 5.9/nm², greater than or equal to 6.0/nm², greater than or equal to 6.1/nm², greater than or equal to 6.2/nm², greater than or equal to 6.3/nm², greater than or equal to 6.4/nm², greater than or equal to 6.5/nm², greater than or equal to 6.6/nm², greater than or equal to 6.7/nm², greater than or equal to 6.8/nm², greater than or equal to 6.9/nm², greater than or equal to 7.0/nm², greater than or equal to 7.1/nm², greater than or equal to 7.2/nm², greater than or equal to 7.3/nm², greater than or equal to 7.4/nm², greater than or equal to 7.5/nm², greater than or equal to 7.6/nm², greater than or equal to 7.7/nm², greater than or equal to 7.8/nm², greater than or equal to 7.9/nm², greater than or equal to 8.0/nm², greater than or equal to 8.5/nm², greater than or equal to 9.0/nm², greater than or equal to 9.5/nm², greater than or equal to 10.0/nm² or any range or value therein between. In some embodiments, the silica particles have the silanol group density of greater than 6.2/nm².

In some embodiments, the silica particles have a silanol group density of 10.0/nm² or less, 9.5/nm² or less, 9.0/nm² or less, 8.5/nm² or less, 8.0/nm² or less, 7.5/nm² or less, 7.0/nm² or less, 6.5/nm² or less, 6.0/nm² or less, 5.5/nm² or less, 5.0/nm² or less, or any range or value therein between. In some embodiments, the silica particles have a silanol group density of 4.0/nm² or less, 3.0/nm² or less, 2.5/nm² or less, 2.4/nm² or less, 2.3/nm² or less, 2.2/nm² or less, or any range or value therein between.

In some embodiments, the silica particles have a silanol group density of 1.0/nm² to 10.0/nm², 1.5/nm² to 9.5/nm², 2.0/nm² to 9.0/nm², 2.5/nm² to 8.5/nm², 3.0/nm² to 8.0/nm², 4.5/nm² to 7.5/nm², 5.0/nm² to 7.0/nm², 5.5/nm² to 6.5/nm², or any range or value therein.

### <Method for Calculating Silanol Group Density>

The silanol group density (unit: number/nm²) per unit surface area of an abrasive is calculated by the following method after each parameter is measured or calculated by the following measurement method or calculation method.

More specifically, C in the following formula is the total mass of the abrasive, and S in the following formula is the BET specific surface area of the abrasive. More specifically, first, 1.50 g of the abrasive as a solid content is taken in a 200 ml beaker, 100 ml of pure water is added to form a slurry, and then 30 g of sodium chloride is added to dissolve the slurry. Next, IN hydrochloric acid is added to adjust the pH of the slurry to 3.0 to 3.5, and then pure water is added until the slurry reaches 150 ml.

For this slurry, the pH is adjusted to 4.0 using 0.1 N sodium hydroxide at 25° C. using an automatic titrator (COM-1700 manufactured by HIRANUMA Co., Ltd.), and the volume V [L] of the 0.1 N sodium hydroxide solution required to increase the pH from 4.0 to 9.0 is measured by pH titration. The average silanol group density (silanol group density) can be calculated by the following formula.

$$ρ = ( c \times V \times {N}_{A} ) / ( C \times S )$$

In the above formula,
ρ represents the average silanol group density (silanol group density) (number/nm²);
c represents the concentration (mol/L) of the sodium hydroxide solution used for the titration;
V represents the volume (L) of sodium hydroxide solution required to raise the pH from 4.0 to 9.0
N_{A} represents an Avogadro constant (number/mol);
C represents the total mass (solid content) (g) of the abrasive; and
S represents a weighted average value (nm²/g) of the BET specific surface area of the abrasive. The BET specific surface area is a value of specific surface area of the abrasive measured by BET method using “MacsorbHM model-1210” manufactured by Mountech Co., Ltd.

### Molybdenum Static Etch Rate Suppressors

As used herein, the term “static etch rate” (SER) means the film thickness change after immersion in a composition (e.g., a polishing composition) divided by the immersion time. For instance, the “Mo static etch rate” is the change in the molybdenum layer thickness after immersion in a composition (e.g., a polishing composition of the present disclosure), divided by the immersion time.

Polishing compositions according to the present disclosure comprise one or more molybdenum static etch rate suppressors (“Mo SER suppressor(s)”). The Mo SER suppressors may comprise one Mo SER suppressor or more than one Mo SER suppressor (e.g., two, three, four, five, or more Mo SER suppressors). In some embodiments, the polishing composition comprises a first Mo SER suppressor and a second Mo SER suppressor. The polishing composition according to the present disclosure comprises a first molybdenum static etch rate suppressor and a second molybdenum static etch rate suppressor, meaning that it comprises two or more Mo SER suppressors.

The one or more Mo SER suppressors are not particularly limited and may comprise any compound or compounds effective to reduce the molybdenum static etch rate while achieving a high molybdenum removal rate, without reducing the polishing composition stability. In some embodiments, the one or more Mo SER suppressors comprises an anionic surfactant having a sulfonic acid moiety, phosphoric acid moiety, or a salt thereof; a triazole compound; an amino acid; or any combination thereof. The sulfonic acid moiety is denoted —SO₃ and the phosphoric acid moiety is denoted —OPO₃.

In some embodiments, the first molybdenum static etch rate suppressor has a diphenyl ether structure. Here, the concept of the diphenyl ether structure includes the structure shown below:

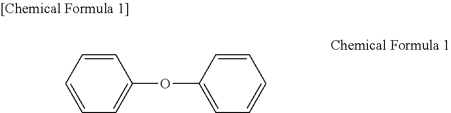 [SMILES: c1ccc(Oc2ccccc2)cc1]

and also includes the structure shown below:

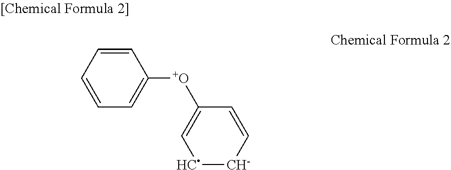

Note that the structure represented by the Formula 2 actually further includes any group (X) (X is, for example, sulfo group (—SO₃H) or the like) that positively charges oxygen atoms in the diphenyl ether structure, as in the following:

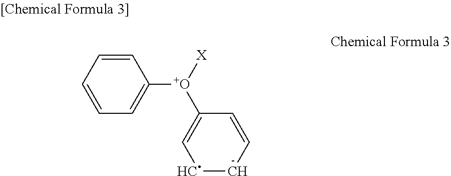

A specific example includes the following structure:

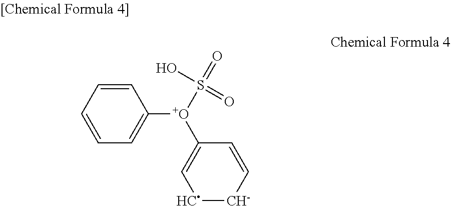

In some embodiments, the first molybdenum static etch rate suppressor has the diphenyl ether structure represented by the following formula:

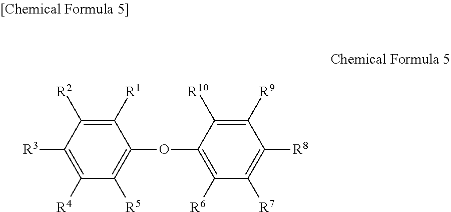

wherein the groups R¹ to R¹⁰ are each independently selected from hydrogen atoms, the sulfo group (—SO₃H) and alkyl group, provided that at least one of the groups R¹ to R¹⁰ is the sulfo group (—SO₃H).

The sulfo group (—SO₃H) may be in the form of salt such as Na. In some embodiments, the number of carbon atoms in the alkyl group is 2 to 15, 3 to 14, 4 to 13, or 5 to 12. In some embodiments, the alkyl group is linear or branched, preferably linear. In some embodiments, among the groups R¹ to R¹⁰, the number of sulfo groups (—SO₃H) is 4 or less, 3 or less, or 2 or less. In some embodiments, among the groups R¹ to R¹⁰, the number of alkyl groups is 4 or less, 3 or less, 2 or less, or 1. In some embodiments, among the groups R¹ to R¹⁰, the number of sulfo groups (—SO₃H) is 1 or 2, the number of alkyl groups is 1 to 4, 1 to 3, or 1 or 2, and the remainder is hydrogen atoms.

In some embodiments, the first molybdenum static etch rate suppressor has the diphenyl ether structure represented by the following formula:

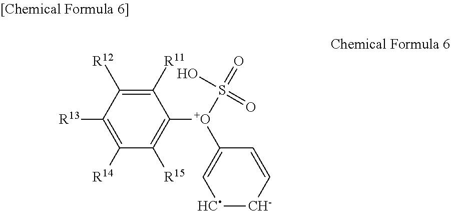

wherein the groups R¹¹ to R¹⁵ are each independently selected from hydrogen atoms, the sulfo group (—SO₃H), and the alkyl group. The sulfo group (—SO₃H) included in the Formula 6 may be in the form of salt such as Na. In some embodiments, the number of carbon atoms in the alkyl group is 1 to 9, 2 to 7, or 3 to 5. In some embodiments, the alkyl group is linear or branched, preferably linear. In some embodiments, among the groups of R¹¹ to R¹⁵, the number of sulfo groups (—SO₃H) is 2 or less, preferably 1. Thus, when the first molybdenum static etch rate suppressor has two sulfo groups (—SO₃H) in one molecule thereof, it is also preferred that one of them is bonded to resonant oxygen. In some embodiments, among the groups of R¹¹ to R¹⁵, the number of alkyl groups is 1 or more, 2 or more, or 3 or more. In some embodiments, among the groups in R¹¹ to R¹⁵, the number of sulfo groups (—SO₃H) is 1 or 2, the number of alkyl groups is 1 to 4, and the remainder are hydrogen atoms.

In some embodiments, the first molybdenum static etch rate suppressor has an oxyalkylene structure and a phosphoric acid moiety (—OPO₃). In some embodiments, the number of carbon atoms of the oxyalkylene structure is 1, 2, or 3. In some embodiments, the first molybdenum static etch rate suppressor is denoted X—(OY)ₙ—OPO₃, n is 3 to 20, X is the alkyl, alkenyl, or aryl group, and Y is alkylene group. The phosphoric acid moiety (—OPO₃) may be in the form of salt such as Na. In some embodiments, n is less than or equal to 17, less than or equal to 15, less than or equal to 13, less than or equal to 11, less than or equal to 10, or less than or equal to 9. In some embodiments, n is 4 or more, 5 or more, 6 or more, or 7 or more. In some embodiments, the number of carbon atoms in the alkyl group is 3 to 20, 4 to 19, 5 to 18, 6 to 17, 7 to 17, 8 to 16, 9 to 15, 10 to 14, or 11 to 13. In some embodiments, the number of carbon atoms in the alkenyl group is 3 to 20, 4 to 19, 5 to 18, 6 to 17, 7 to 17, 8 to 16, 9 to 15, 10 to 14, or 11 to 13. In some embodiments, the aryl group is a phenyl group or a naphthyl group. In some embodiments, the number of carbon atoms in the alkylene group is 1, 2, or 3.

In some embodiments, the first molybdenum static etch rate suppressor has two or more sulfonic acid moieties (—SO₃) in a molecule. The first molybdenum static etch rate suppressor has no more than 5, no more than 4, or no more than 3 sulfonic acid moieties (—SO₃) in a molecule.

In some embodiments, the one or more Mo SER suppressors comprises at least one selected from dodecyl(sulfonatophenoxy)benzenesulfonate or salts thereof (e.g., disodium dodecyl(sulfonatophenoxy)benzenesulfonate (CAS No. 28519-02-0)); sulfonated benzene, 1,1′-oxybis-, sec-hexyl derivatives (CAS No. 147732-59-0); sulfonated benzene, 1,1′-oxybis-, tetrapropylene derivatives (CAS No. 119345-03-8); polyoxyethylene (10) oleyl ether phosphate; polyoxyethylene (8) phenyl phosphate; polyoxyethylene (14) oleyl ether phosphate; polyoxyethylene (10) alkyl ether phosphate; polyoxyethylene (8) tridecyl ether phosphate; polyoxyethylene (10) tridecyl ether phosphate; polyoxyethylene (12) tridecyl ether phosphate; and salts thereof. In some embodiments, the one or more Mo SER suppressors comprises at least one selected from the group consisting of: dodecyl(sulfonatophenoxy)benzenesulfonate or salts thereof (e.g., disodium dodecyl(sulfonatophenoxy)benzenesulfonate (CAS No. 28519-02-0)); sulfonated benzene, 1,1′-oxybis-, sec-hexyl derivatives (CAS No. 147732-59-0); sulfonated benzene, 1,1′-oxybis-, tetrapropylene derivatives (CAS No. 119345-03-8); and salts thereof. In some embodiments, the molybdenum static etch rate suppressor is disodium dodecyl(sulfonatophenoxy)benzenesulfonate (CAS No. 28519-02-0) or a salt thereof.

In some embodiments, the one or more Mo SER suppressors comprises a triazole compound, an amino acid, or any combination thereof. In some embodiments the triazole compound comprises benzotriazole, benzotriazole-5-carboxylic acid (CAS No. 60932-58-3 or CAS No. 23814-12-2), or 2,2′-[[(methyl-1H-benzotriazol-1-yl)methyl]imino]bis-ethanol (CAS No. 88477-37-6). In some embodiments the triazole compound comprises benzotriazole. In some embodiments, the amino acid is one or more selected from arginine (e.g., L-arginine), histidine (e.g., L-histidine), lysine (e.g., L-lysine), aspartic acid, glutamic acid, glycine, alanine, or any combination thereof. In some embodiments, the one or more Mo SER suppressors comprises a basic amino acid. In some embodiments, the one or more Mo SER suppressors comprises at least one selected from the group consisting of: arginine, histidine, and lysine. In some embodiments, the one or more Mo SER suppressors comprises arginine. In some embodiments, the proportion of basic amino acid in the amino acid contained in the composition is greater than or equal to 80 wt. %, greater than or equal to 85 wt. %, greater than or equal to 90 wt. %, greater than or equal to 95 wt. %, greater than or equal to 98 wt. %, or greater than or equal to 99 wt. % (upper limit: 100 wt. %).

In some embodiments the composition comprises a first Mo SER suppressor selected from anionic surfactants having a sulfonic acid moiety, phosphoric acid moiety, or a salt thereof; and a second Mo SER suppressor selected from amino acids. In some embodiments, the polishing composition comprises a first Mo SER suppressor selected from dodecyl(sulfonatophenoxy)benzenesulfonate or salts thereof (e.g., disodium dodecyl(sulfonatophenoxy)benzenesulfonate (CAS No. 28519-02-0)); sulfonated benzene, 1,1′-oxybis-, sec-hexyl derivatives (CAS No. 147732-59-0); sulfonated benzene, 1,1′-oxybis-, tetrapropylene derivatives (CAS No. 119345-03-8); polyoxyethylene (10) oleyl ether phosphate; polyoxyethylene (8) phenyl phosphate; polyoxyethylene (14) oleyl ether phosphate; polyoxyethylene (10) alkyl ether phosphate; polyoxyethylene (8) tridecyl ether phosphate; polyoxyethylene (10) tridecyl ether phosphate; polyoxyethylene (12) tridecyl ether phosphate; and salts thereof; and a second Mo SER suppressor selected from arginine, histidine, and lysine. In some embodiments, the polishing composition comprises: a first Mo SER suppressor that is disodium dodecyl(sulfonatophenoxy)benzenesulfonate (CAS No. 28519-02-0); and a second Mo SER suppressor that is arginine.

The one or more Mo SER suppressors may be present in the polishing composition at any suitable concentration for reducing the molybdenum static etch rate while achieving a high molybdenum removal rate, without reducing the polishing composition stability. In some embodiments, the one or more Mo SER suppressors are present in the polishing composition, individually or collectively, at a concentration (by weight relative to the total weight of the composition) of greater than or equal to about 0.001 wt. %, greater than or equal to about 0.005 wt. %, greater than or equal to about 0.01 wt. %, greater than or equal to about 0.02 wt. %, greater than or equal to about 0.03 wt. %, greater than or equal to about 0.04 wt. %, greater than or equal to about 0.05 wt. %, greater than or equal to about 0.06 wt. %, greater than or equal to about 0.07 wt. %, greater than or equal to about 0.08 wt. %, greater than or equal to about 0.09 wt. %, greater than or equal to about 0.1 wt. %, greater than or equal to about 0.2 wt. %, greater than or equal to about 0.3 wt. %, greater than or equal to about 0.4 wt. %, greater than or equal to about 0.5 wt. %, greater than or equal to about 0.6 wt. %, greater than or equal to about 0.7 wt. %, greater than or equal to about 0.8 wt. %, greater than or equal to about 0.9 wt. %, greater than or equal to about 1.0 wt. %, greater than or equal to about 1.5 wt. %, greater than or equal to about 2.0 wt. %, greater than or equal to about 2.5 wt. %, greater than or equal to about 3.0 wt. %, greater than or equal to about 3.5 wt. %, greater than or equal to about 4.0 wt. %, greater than or equal to about 4.5 wt. %, greater than or equal to about 5 wt. %, greater than or equal to about 6 wt. %, greater than or equal to about 7 wt. %, greater than or equal to about 8 wt. %, greater than or equal to about 9 wt. %, greater than or equal to about 10 wt. %, or any range or value therein between.

In some embodiments, the one or more Mo SER suppressors are present in the polishing composition, individually or collectively, at a concentration (by weight relative to the total weight of the composition) of less than or equal to about 10 wt. %, less than or equal to about 9 wt. %, less than or equal to about 8 wt. %, less than or equal to about 7 wt. %, less than or equal to about 6 wt. %, less than or equal to about 5 wt. %, less than or equal to about 4.5 wt. %, less than or equal to about 4.0 wt. %, less than or equal to about 3.5 wt. %, less than or equal to about 3.0 wt. %, less than or equal to about 2.5 wt. %, less than or equal to about 2.0 wt. %, less than or equal to about 1.5 wt. %, less than or equal to about 1.0 wt. %, less than or equal to about 0.9 wt. %, less than or equal to about 0.8 wt. %, less than or equal to about 0.7 wt. %, less than or equal to about 0.6 wt. %, less than or equal to about 0.5 wt. %, less than or equal to about 0.4 wt. %, less than or equal to about 0.3 wt. %, less than or equal to about 0.2 wt. %, less than or equal to about 0.1 wt. %, less than or equal to about 0.05 wt. %, less than or equal to about 0.01 wt. %, less than or equal to about 0.005 wt. %, or any range or value therein between. By providing appropriate upper limit to the concentration of the Mo SER suppressor rather than randomly increasing it, there is the effect of having the high removal rate while achieving the low static etch rate (SER) for molybdenum.

In some embodiments, the one or more Mo SER suppressors are present in the polishing composition, individually or collectively, at a concentration (by weight relative to the total weight of the composition) of about 0.001 wt. % to about 10 wt. %, about 0.001 wt. % to about 5 wt. %, about 0.001 wt. % to about 1 wt. %, about 0.001 wt. % to about 0.7 wt. %, about 0.001 wt. % to about 0.5 wt. %, about 0.001 wt. % to about 0.1 wt. %, about 0.001 wt. % to about 0.05 wt. %, about 0.001 wt. % to about 0.01 wt. %, about 0.005 wt. % to about 10 wt. %, about 0.005 wt. % to about 5 wt. %, about 0.005 wt. % to about 1 wt. %, about 0.005 wt. % to about 0.7 wt. %, about 0.005 wt. % to about 0.5 wt. %, about 0.005 wt. % to about 0.1 wt. %, about 0.005 wt. % to about 0.05 wt. %, about 0.005 wt. % to about 0.01 wt. %, about 0.01 wt. % to about 10 wt. %, about 0.01 wt. % to about 5 wt. %, about 0.01 wt. % to about 1 wt. %, about 0.01 wt. % to about 0.7 wt. %, about 0.01 wt. % to about 0.5 wt. %, about 0.01 wt. % to about 0.1 wt. %, or any range or value therein.

In some embodiments, the one or more Mo SER suppressors are present in the polishing composition individually or collectively (by total concentration) at a concentration of about 0.03 wt. % to about 1.0 wt. % or less, or any range or value therein (by weight relative to the total weight of the composition). In some embodiments, the one or more Mo SER suppressors are present in the polishing composition individually or collectively (by total concentration) at a concentration of about 0.07 wt. % to about 1.0 wt. % or less, or any range or value therein (by weight relative to the total weight of the composition). In some embodiments, the polishing composition comprises a first SER suppressor having a sulfonic acid moiety (—SO₃), phosphoric acid moiety (—OPO₃), or a salt thereof at a concentration of about 0.02 wt. % to about 0.4 wt. % relative to the total weight of the composition, and a second SER suppressor having an amino acid structure at a concentration of about 0.02 wt. % to about 1 wt. % relative to the total weight of the composition. By providing appropriate upper limit and appropriate lower limit for the concentration of the Mo SER suppressor rather than randomly increasing it, there is an effect of having the high removal rate while achieving the low static etch rate (SER) for molybdenum. This concentration adjustment is because the present inventors have found that the SER suppressor has a trade-off effect of achieving the low static etching rate (SER) and achieving the high removal rate.

In some embodiments, the polishing composition comprises a first Mo SER suppressor that is disodium dodecyl(sulfonatophenoxy)benzenesulfonate (CAS No. 28519-02-0) at a concentration of about 0.005 wt. % to about 1 wt. %, relative to the total weight of the composition; and a second Mo SER suppressor that is arginine at a concentration of about 0.01 wt. % to about 1.0 wt. %, relative to the total weight of the composition. In some embodiments, the polishing composition comprises a first Mo SER suppressor that is disodium dodecyl(sulfonatophenoxy)benzenesulfonate (CAS No. 28519-02-0) at a concentration of about 0.01 wt. % to about 0.7 wt. %, relative to the total weight of the composition; and a second Mo SER suppressor that is arginine at a concentration of about 0.05 wt. % to about 0.7 wt. %, relative to the total weight of the composition.

### Oxidizers

Polishing compositions according to the present disclosure comprise one or more oxidizers. In some embodiments, a polishing composition according to the present disclosure comprises a first oxidizer and a second oxidizer. The polishing composition may comprise more than two oxidizers (e.g., three, four, five, or more oxidizers). The polishing composition according to the present disclosure comprises the first oxidizer and the second oxidizer, which means that the polishing composition comprises two or more oxidizers.

The first and the second oxidizers are not particularly limited and may comprise any compound or compounds effective to reduce the molybdenum static etch rate while achieving a high molybdenum removal rate, without reducing the polishing composition stability.

In some embodiments, the first oxidizer comprises one or more transition metal compounds (e.g., transition metal halides). In some embodiments, the first oxidizer is not a peroxide. In some embodiments, the first oxidizer comprises one or more compounds selected from: a silver (II) salt, an iron (III) salt, permanganic acid, chromic acid, dichromatic acid, hypochlorous acid, hypobromous acid, hypoiodous acid, chloric acid, chlorous acid, perchloric acid, bromic acid, iodic acid, periodic acid, dichloroisocyanuric acid, potassium iodate, potassium permanganate, and salts thereof.

In some embodiments, the second oxidizer comprises one or more peroxides. In some embodiments, the second oxidizer comprises one or more compounds selected from: hydrogen peroxide, sodium peroxide, barium peroxide, ozone water, peroxodisulfuric acid, peroxophosphoric acid, peroxosulfuric acid, peroxoboric acid, performic acid, peracetic acid, perbenzoic acid, perphthalic acid, persulfuric acid, and salts thereof.

In some embodiments, the first oxidizer comprises potassium iodate and the second oxidizer comprises hydrogen peroxide. In some embodiments, the first oxidizer comprises potassium iodate and the second oxidizer comprises hydrogen peroxide.

The first oxidizer and the second oxidizer may be present in the polishing composition at any suitable concentration for reducing the molybdenum static etch rate while achieving a high molybdenum removal rate, without reducing the polishing composition stability. In some embodiments, the one or more oxidizers are present in the polishing composition, individually or collectively, at a concentration (by weight relative to the total weight of the composition) of greater than or equal to about 0.001 wt. %, greater than or equal to about 0.005 wt. %, greater than or equal to about 0.01 wt. %, greater than or equal to about 0.02 wt. %, greater than or equal to about 0.03 wt. %, greater than or equal to about 0.04 wt. %, greater than or equal to about 0.05 wt. %, greater than or equal to about 0.06 wt. %, greater than or equal to about 0.07 wt. %, greater than or equal to about 0.08 wt. %, greater than or equal to about 0.09 wt. %, greater than or equal to about 0.1 wt. %, greater than or equal to about 0.2 wt. %, greater than or equal to about 0.3 wt. %, greater than or equal to about 0.4 wt. %, greater than or equal to about 0.5 wt. %, greater than or equal to about 0.6 wt. %, greater than or equal to about 0.7 wt. %, greater than or equal to about 0.8 wt. %, greater than or equal to about 0.9 wt. %, greater than or equal to about 1.0 wt. %, greater than or equal to about 1.5 wt. %, greater than or equal to about 2.0 wt. %, greater than or equal to about 2.5 wt. %, greater than or equal to about 3.0 wt. %, greater than or equal to about 3.5 wt. %, greater than or equal to about 4.0 wt. %, greater than or equal to about 4.5 wt. %, greater than or equal to about 5 wt. %, greater than or equal to about 6 wt. %, greater than or equal to about 7 wt. %, greater than or equal to about 8 wt. %, greater than or equal to about 9 wt. %, greater than or equal to about 10 wt. %, or any range or value therein between.

In some embodiments, the first and the second oxidizers are present in the polishing composition, individually or collectively, at a concentration (by weight relative to the total weight of the composition) of less than or equal to about 10 wt. %, less than or equal to about 9 wt. %, less than or equal to about 8 wt. %, less than or equal to about 7 wt. %, less than or equal to about 6 wt. %, less than or equal to about 5 wt. %, less than or equal to about 4.5 wt. %, less than or equal to about 4.0 wt. %, less than or equal to about 3.5 wt. %, less than or equal to about 3.0 wt. %, less than or equal to about 2.5 wt. %, less than or equal to about 2.0 wt. %, less than or equal to about 1.5 wt. %, less than or equal to about 1.0 wt. %, less than or equal to about 0.9 wt. %, less than or equal to about 0.8 wt. %, less than or equal to about 0.7 wt. %, less than or equal to about 0.6 wt. %, less than or equal to about 0.5 wt. %, less than or equal to about 0.4 wt. %, less than or equal to about 0.3 wt. %, less than or equal to about 0.2 wt. %, less than or equal to about 0.1 wt. %, less than or equal to about 0.05 wt. %, less than or equal to about 0.01 wt. %, less than or equal to about 0.005 wt. %, or any range or value therein between.

In some embodiments, the first and the second oxidizers are present in the polishing composition, individually or collectively, at a concentration (by weight relative to the total weight of the composition) of about 0.001 wt. % to about 10 wt. %, about 0.001 wt. % to about 5 wt. %, about 0.001 wt. % to about 1 wt. %, about 0.001 wt. % to about 0.7 wt. %, about 0.001 wt. % to about 0.5 wt. %, about 0.001 wt. % to about 0.1 wt. %, about 0.001 wt. % to about 0.05 wt. %, about 0.001 wt. % to about 0.01 wt. %, about 0.005 wt. % to about 10 wt. %, about 0.005 wt. % to about 5 wt. %, about 0.005 wt. % to about 1 wt. %, about 0.005 wt. % to about 0.7 wt. %, about 0.005 wt. % to about 0.5 wt. %, about 0.005 wt. % to about 0.1 wt. %, about 0.005 wt. % to about 0.05 wt. %, about 0.005 wt. % to about 0.01 wt. %, about 0.01 wt. % to about 10 wt. %, about 0.01 wt. % to about 5 wt. %, about 0.01 wt. % to about 1 wt. %, about 0.01 wt. % to about 0.7 wt. %, about 0.01 wt. % to about 0.5 wt. %, about 0.01 wt. % to about 0.1 wt. %, about 0.05 wt. % to about 10 wt. %, about 0.05 wt. % to about 5.0 wt. %, about 0.05 wt. % to about 1.0 wt. %, about 0.05 wt. % to about 0.7 wt. %, about 0.05 wt. % to about 0.5 wt. %, about 0.05 wt. % to about 0.1 wt. %, about 0.05 wt. % to about 0.07 wt. %, about 0.1 wt. % to about 10 wt. %, about 0.1 wt. % to about 5.0 wt. %, about 0.1 wt. % to about 2.5 wt. %, about 0.1 wt. % to about 2.0 wt. %, about 0.1 wt. % to about 1.5 wt. %, about 0.1 wt. % to about 1.0 wt. %, about 0.1 wt. % to about 0.7 wt. %, about 0.1 wt. % to about 0.5 wt. %, about 0.5 wt. % to about 10 wt. %, about 0.5 wt. % to about 5.0 wt. %, about 0.5 wt. % to about 2.5 wt. %, about 0.5 wt. % to about 2.0 wt. %, about 0.5 wt. % to about 1.5 wt. %, about 0.5 wt. % to about 1.0 wt. %, about 0.5 wt. % to about 0.7 wt. %, about 1.0 wt. % to about 10.0 wt. %, about 1.0 wt. % to about 5.0 wt. %, about 1.0 wt. % to about 2.5 wt. %, about 1.0 wt. % to about 2.0 wt. %, about 1.0 wt. % to about 1.5 wt. %, or any range or value therein.

In some embodiments, the polishing composition comprises first oxidizer that is potassium iodate at a concentration of about 0.01 wt. % to 1.0 wt. %, relative to the total weight of the composition; and a second oxidizer that is hydrogen peroxide at a concentration of about 0.01 wt. % to 5.0 wt. %, relative to the total weight of the composition. In some embodiments, the polishing composition comprises the first oxidizer that is iodic acid or a salt thereof at a concentration of about 0.01 wt. % to 1.0 wt. % relative to the total weight of the composition; and the second oxidizer that is hydrogen peroxide at a concentration of about 0.01 wt. % to 5.0 wt. %, relative to the total weight of the composition. In some embodiments, the polishing composition comprises a first oxidizer that is potassium iodate at a concentration of about 0.05 wt. % to about 0.7 wt. %, relative to the total weight of the composition; and a second oxidizer that is hydrogen peroxide at a concentration of about 0.5 wt. % to 1.5 wt. %, relative to the total weight of the composition. In some embodiments, the polishing composition comprises the first oxidizer that is iodic acid or a salt thereof at a concentration of about 0.05 wt. % to about 0.7 wt. % relative to the total weight of the composition; and the second oxidizer that is hydrogen peroxide at a concentration of about 0.5 wt. % to 1.5 wt. %, relative to the total weight of the composition.

In some embodiments, the concentration of the second oxidizer that is hydrogen peroxides is greater than or equal to 1.2 times, greater than or equal to 1.4 times, greater than or equal to 1.6 times, or greater than or equal to 1.8 times relative to the concentration of the first oxidizer that is iodic acid or a salt thereof. In some embodiments, the concentration of the second oxidizer that is hydrogen peroxide is less than or equal to 5.5 times, less than or equal to 4.5 times, less than or equal to 3 times, or less than or equal to 2.5 times relative to the concentration of the first oxidizer that is iodic acid or a salt thereof.

In some embodiments, the proportion of potassium iodate and hydrogen peroxide in the oxidizer contained in the composition is greater than or equal to 80 wt. %, greater than or equal to 85 wt. %, greater than or equal to 90 wt. %, greater than or equal to 95 wt. %, greater than or equal to 98 wt. %, or greater than or equal to 99 wt. % (upper limit: 100 wt. %).

### pH Adjusting Agent

In some embodiments, a composition according to the present disclosure may further comprise one or more pH adjusting agents to adjust the pH to a selected pH value.

The pH adjusting agent is not particularly limited, and any suitable pH adjusting agent may be used to bring the pH of the composition into any desired range, as discussed above. In some embodiments, the one or more pH adjusting agents may comprise, consist essentially of, or consist of an inorganic compound, an organic compound, or combinations thereof. In some embodiments, the one or more pH adjusting agents may comprise inorganic acids (e.g., hydrochloric acid, hydrobromic acid, hydroiodic acid, sulfuric acid, nitric acid, boric acid, carbonic acid, hypophosphorous acid, phosphorous acid, and phosphoric acid); organic acids (e.g., carboxylic acids such as citric acid, formic acid, acetic acid, propionic acid, benzoic acid, salicylic acid, glyceric acid, oxalic acid, malonic acid, succinic acid, maleic acid, phthalic acid, malic acid, tartaric acid, and lactic acid); and/or organic sulfuric acids (e.g., methane sulfonic acid, ethane sulfonic acid, isethionic acid, etc.). In some embodiments, the one or more pH adjusting agents may comprise a divalent or higher acid of the above acid(s) (e.g., sulfuric acid, carbonic acid, phosphoric acid, oxalic acid, etc.), which may be in the form of a base when one or more protons (H⁺) can be released (e.g., ammonium hydrogen carbonate or ammonium hydrogen phosphate), but any counter-ion may be used (e.g., weakly basic cations, such as ammonium, triethanolamine, etc.). In some embodiments, the one or more pH adjusting agents comprises phosphoric acid.

In some embodiments, the one or more pH adjusting agents may comprise one or more hydroxides of alkali metals (e.g., NaOH, KOH), or salts thereof (e.g., carbonates, hydrogen carbonates, sulfates, acetates, etc.); quaternary ammonium compounds (e.g., tetramethylammonium, tetraethylammonium, tetrabutylammonium, etc.); quaternary ammonium hydroxides (e.g., tetramethylammonium hydroxide, tetraethylammonium hydroxide, tetrabutylammonium hydroxide) or a salts thereof; ammonia; amines; or any other suitable pH adjusting agent. In some embodiments, the one or more pH adjusting agents comprises KOH.

### pH of Polishing Composition

The pH adjust agent may be present in any amount suitable to achieve a desired pH value to obtain oppositely charged surfaces of a first material (e.g., SiN) and a second material (e.g., SiO₂), as discussed above. The pH of the polishing composition may be measured using any suitable method known in the art (e.g., using a ThermoFisher Scientific ORION™ VERSA STAR PRO™ pH/ISE/conductivity/dissolved oxygen multiparameter benchtop meter).

In some embodiments, the pH of the composition is less than or equal to about 10.0, less than or equal to about 9.9, less than or equal to about 9.8, less than or equal to about 9.7, less than or equal to about 9.6, less than or equal to about 9.5, less than or equal to about 9.4, less than or equal to about 9.3, less than or equal to about 9.2, less than or equal to about 9.1, less than or equal to about 9.0, less than or equal to about 8.9, less than or equal to about 8.8, less than or equal to about 8.7, less than or equal to about 8.6, less than or equal to about 8.5, less than or equal to about 8.4, less than or equal to about 8.3, less than or equal to about 8.2, less than or equal to about 8.1, less than or equal to about 8.0, less than or equal to about 7.9, less than or equal to about 7.8, less than or equal to about 7.7, less than or equal to about 7.6, less than or equal to about 7.5, less than or equal to about 7.4, less than or equal to about 7.3, less than or equal to about 7.2, less than or equal to about 7.1, less than or equal to about 7.0, less than or equal to about 6.9, less than or equal to about 6.8, less than or equal to about 6.7, less than or equal to about 6.6, less than or equal to about 6.5, less than or equal to about 6.4, less than or equal to about 6.3, less than or equal to about 6.2, less than or equal to about 6.1, less than or equal to about 6.0, less than or equal to about 5.9, less than or equal to about 5.8, less than or equal to about 5.7, less than or equal to about 5.6, less than or equal to about 5.5, less than or equal to about 5.4, less than or equal to about 5.3, less than or equal to about 5.2, less than or equal to about 5.1, less than or equal to about 5.0, less than or equal to about 4.9, less than or equal to about 4.8, less than or equal to about 4.7, less than or equal to about 4.6, less than or equal to about 4.5, less than or equal to about 4.4, less than or equal to about 4.3, less than or equal to about 4.2, less than or equal to about 4.1, less than or equal to about 4.0, less than or equal to about 3.9, less than or equal to about 3.8, less than or equal to about 3.7, less than or equal to about 3.6, less than or equal to about 3.5, less than or equal to about 3.4, less than or equal to about 3.3, less than or equal to about 3.2, less than or equal to about 3.1, less than or equal to about 3.0, or less.

In some embodiments, the pH of the composition is greater than or equal to about 3.0, greater than or equal to about 3.1, greater than or equal to about 3.2, greater than or equal to about 3.3, greater than or equal to about 3.4, greater than or equal to about 3.5, greater than or equal to about 3.6, greater than or equal to about 3.7, greater than or equal to about 3.8, greater than or equal to about 3.9, greater than or equal to about 4.0, greater than or equal to about 4.1, greater than or equal to about 4.2, greater than or equal to about 4.3, greater than or equal to about 4.4, greater than or equal to about 4.5, greater than or equal to about 4.6, greater than or equal to about 4.7, greater than or equal to about 4.8, greater than or equal to about 4.9, greater than or equal to about 5.0, greater than or equal to about 5.1, greater than or equal to about 5.2, greater than or equal to about 5.3, greater than or equal to about 5.4, greater than or equal to about 5.5, greater than or equal to about 5.6, greater than or equal to about 5.7, greater than or equal to about 5.8, greater than or equal to about 5.9, greater than or equal to about 6.0, greater than or equal to about 6.1, greater than or equal to about 6.2, greater than or equal to about 6.3, greater than or equal to about 6.4, greater than or equal to about 6.5, greater than or equal to about 6.6, greater than or equal to about 6.7, greater than or equal to about 6.8, greater than or equal to about 6.9, greater than or equal to about 7.0, greater than or equal to about 7.1, greater than or equal to about 7.2, greater than or equal to about 7.3, greater than or equal to about 7.4, greater than or equal to about 7.5, greater than or equal to about 7.6, greater than or equal to about 7.7, greater than or equal to about 7.8, greater than or equal to about 7.9, greater than or equal to about 8.0, greater than or equal to about 8.1, greater than or equal to about 8.2, greater than or equal to about 8.3, greater than or equal to about 8.4, greater than or equal to about 8.5, greater than or equal to about 8.6, greater than or equal to about 8.7, greater than or equal to about 8.8, greater than or equal to about 8.9, greater than or equal to about 9.0, or any range or value therein between.

In some embodiments, the pH of the composition is about 3 to about 10, about 3.5 to about 9.5, about 4 to about 9, about 4.5 to about 8.5, about 5 to about 8, about 5.5 to about 7.5, about 6 to about 7. In some embodiments, the pH of the composition is about 4 to about 9, such as about 4.0, 4.5, 5.0, 5.5, 6.0, 6.5, 7.0, 7.5, 8.0, 8.5, or 9.0, or any range or value therein between. In some embodiments, the pH of the composition is about 4.5 to about 8.1 or less. In some embodiments, the pH of the composition is about 5.0 to about 8.0 or less. In some embodiments, the pH of the composition is about 5.0 to about 7.8 or less. In some embodiments, the pH of the composition is about 5.5 to about 7.5 or less. In some embodiments, the pH of the composition is greater than 4. In some embodiments, the pH of the composition is less than 9.

### Liquid Carrier

Polishing compositions according to the present disclosure may comprise a liquid carrier. The liquid carrier of the polishing composition is not particularly limited. In some embodiments, the liquid carrier is water, such as deionized water. The liquid carrier may also be an aqueous solution that has, e.g., an appropriate pH modifier contained therein. In some embodiments, the liquid carrier can comprise one or more organic solvents, such as an alcohol compound, e.g., glycol ethers of aliphatic alcohols and 3 to 10 carbon atoms having 2 to 6 carbon atoms. Examples of aliphatic alcohols with 2 to 6 carbon atoms include ethanol. 1-propanol, 2-propanol, 1-butanol, 2-butanol, tert-butanol, pentanol, hexanol, ethylene glycol, propylene glycol, 1,3-butanediol, 1,4-butanediol, 1,5-pentanediol, 1,6-hexanediol, glycerin, 1,2,4-butanetriol, 1,2,6-hexanetriol, erythritol, D-threitol, L-threilol, D-arabinitol, L-arabinitol, ribitol, xylitol, mannitol, and sorbitol. Examples of glycol ethers with 3 to 10 carbon atoms include methyl glycol, methyl diglycol, methyl triglycol, isopropyl glycol, isopropyl diglycol, butyl glycol, butyl diglycol, butyl triglycol, isobutyl glycol, isobutyl diglycol, hexyl glycol, hexyl diglycol, 2-ethylhexyl glycol, 2-ethylhexyl diglycol, aryl glycol, phenyl glycol, phenyl diglycol, benzyl glycol, methylpropylene glycol, methylpropylene diglycol, methylpropylene triglycol, propylpropylene glycol, propylpropylene diglycol, butylpropylene glycol, butylpropylene diglycol, and phenylpropylene glycol. In some embodiments, greater than or equal to 80 wt. %, greater than or equal to 85 wt. %, greater than or equal to 90 wt. %, greater than or equal to 95 wt. %, greater than or equal to 98 wt. %, or greater than or equal to 99 wt. % of the liquid carriers included in the composition is water (upper limit is 100 wt. %).

### Additional Ingredients

In some embodiments, the composition may comprise other additives at any concentration. However, it is desirable not to add unnecessary components, which may cause the presence of surface defects. Thus, it is preferred that any other additives are present in relatively small concentrations (e.g., 0.1 wt. % or less, 0.05 wt. % or less, 0.01 wt. % or less, 0.005 wt. % or less, 0.001 wt. % or less, 0.0005 wt. % or less, 0.0001 wt. % or less, 0.0001 wt. % to 0.1 wt. %, 0.0001 wt. % to 0.01 wt. %, or 0.0001 wt. % to 0.001 wt. %, etc.) if they are present at all. Examples of other additives include preservatives, antifungal agents, biocides (e.g., isothiazolinones such as methylisothiazolinone (“MIT”), benzisothiazolinone (“BIT”), 2-methyl-4 isothiazolin-3-one), dispersants (additives that improve the redispersibility of the abrasive that have once settled), electrical conductivity adjusting agents (additives that adjust the electrical conductivity of the polishing composition), abrasives other than the above abrasives, chelating agents, oxidizers, reducing agents, and dissolved gases.

### Polishing Methods

In another aspect, the present disclosure relates to a polishing method, comprising: contacting a molybdenum surface with the polishing composition according to the present disclosure; and removing molybdenum from the molybdenum surface.

In some embodiments the molybdenum is removed from the molybdenum surface at a removal rate (RR) of greater than or equal to about 200 Å/min, greater than or equal to about 250 Å/min, greater than or equal to about 300 Å/min, greater than or equal to about 350 Å/min, greater than or equal to about 400 Å/min, greater than or equal to about 450 Å/min, greater than or equal to about 500 Å/min, greater than or equal to about 550 Å/min, greater than or equal to about 600 Å/min, greater than or equal to about 650 Å/min, greater than or equal to about 700 Å/min, greater than or equal to about 750 Å/min, greater than or equal to about 800 Å/min, greater than or equal to about 850 Å/min, greater than or equal to about 900 Å/min, greater than or equal to about 950 Å/min, greater than or equal to about 1000 Å/min, greater than or equal to about 1050 Å/min, greater than or equal to about 1100 Å/min, greater than or equal to about 1150 Å/min, greater than or equal to about 1200 Å/min, greater than or equal to about 1250 Å/min, greater than or equal to about 1300 Å/min, greater than or equal to about 1350 Å/min, greater than or equal to about 1400 Å/min, greater than or equal to about 1450 Å/min, greater than or equal to about 1500 Å/min, or any range or value therein between.

In some embodiments, the polishing achieves a low Mo static etch rate (SER). In some embodiments, the Mo SER is less than or equal to about 1200 Å/min, less than or equal to about 1150 Å/min, less than or equal to about 1100 Å/min, less than or equal to about 1050 Å/min, less than or equal to about 1000 Å/min, less than or equal to about 950 Å/min, less than or equal to about 900 Å/min, less than or equal to about 850 Å/min, less than or equal to about 800 Å/min, less than or equal to about 750 Å/min, less than or equal to about 700 Å/min, less than or equal to about 650 Å/min, less than or equal to about 600 Å/min, less than or equal to about 550 Å/min, less than or equal to about 500 Å/min, less than or equal to about 450 Å/min, less than or equal to about 400 Å/min, less than or equal to about 350 Å/min, less than or equal to about 300 Å/min, less than or equal to about 250 Å/min, less than or equal to about 200 Å/min, less than or equal to about 190 Å/min, less than or equal to about 180 Å/min, less than or equal to about 170 Å/min, less than or equal to about 160 Å/min, less than or equal to about 150 Å/min, less than or equal to about 140 Å/min, less than or equal to about 130 Å/min, less than or equal to about 120 Å/min, less than or equal to about 110 Å/min, less than or equal to about 100 Å/min, less than or equal to about 90 Å/min, less than or equal to about 80 Å/min, less than or equal to about 70 Å/min, less than or equal to about 60 Å/min, less than or equal to about 50 Å/min, less than or equal to about 40 Å/min, less than or equal to about 30 Å/min, or any range or value therein between.

In some embodiments, the polishing achieves a ratio of Mo RR to Mo SER of at least about 2, at least about 2.5, at least about 3, at least about 3.5, at least about 4, at least about 4.5, at least about 5, at least about 5.5, at least about 6, at least about 6.5, at least about 7, at least about 7.5, at least about 8, at least about 8.5, at least about 9, at least about 9.5, at least about 10, at least about 10.5, at least about 11, at least about 11.5, at least about 12, or greater. In some embodiments, the polishing achieves a ratio of Mo RR to Mo SER of greater than 6.0, greater than or equal to 6.2, greater than or equal to 6.4, greater than or equal to 6.6, greater than or equal to 6.8, greater than or equal to 7.0, greater than or equal to 7.2, greater than or equal to 7.4, greater than or equal to 7.6, greater than or equal to 7.8, greater than or equal to 8.0, greater than or equal to 8.2, greater than or equal to 8.4, greater than or equal to 8.6, greater than or equal to 8.8, greater than or equal to 9.0, greater than or equal to 9.2, greater than or equal to 9.4, greater than or equal to 9.6, greater than or equal to 9.8, greater than or equal to 10.0, greater than or equal to 10.2, greater than or equal to 10.4, greater than or equal to 10.6, greater than or equal to 10.8, or greater than or equal to 11.0. In some embodiments, the polishing achieves a ratio of Mo RR to Mo SER of 20 or less, alternatively 18 or less.

### EXAMPLES

### Example 1. Preparation of Polishing Compositions

To test the polishing performance of polishing compositions according the present disclosure in terms of Mo removal rate, Mo static etch rate suppression, and Mo RR-to-SER selectivity, polishing compositions were prepared as follows:

For the exemplary polishing compositions used in the experiments below, polishing compositions were prepared by adding the following ingredients to a container, while mixing, in the following order: (1) deionized water (80% of total deionized water); (2) first SER suppressor; (3) second SER suppressor; (4) second oxidizer; (5) abrasive; (6) deionized water (20% of total deionized water); (7) pH adjuster; and (8) first oxidizer. In some examples, at least one component such as (3) the second SER suppressor is not contained.

The polishing compositions were prepared using different abrasive types (as shown in Table 1) and using different Mo SER suppressors (shown in Table 2).

To test the Mo removal rate, polishing compositions (Examples 1-67) were applied to a Mo-coated substrate including (from the top down): 200 nm PVD Mo on 50 nm PE-CVD SiN on thermal SiO₂ on Si substrate, using a table top polisher operated using the following polishing conditions:
Pad: FUJIBO H800;
Conditioner: 3M nylon brush;
Down force: 2.0 psi;
Platen rotation: 150 rpm;
Slurry flow rate: 30 ml/min;
Polishing time: 30 sec.

To determine the Mo removal rate, the thickness of the Mo layer was measured before and after polishing, then divided by the polishing time. To determine the Mo static etch rate (SER), the thickness of the Mo layer was measured before and after pre-treating (cleaning) the substrate by immersing it in 0.5 wt. % citric acid solution and rinsing with deionized water for 2 min, followed by immersing the substrate in 300 ml of the polishing composition for 2 min at 40° C.

TABLE 1
Abrasive Types

| Abrasive | Average Primary | Mean Particle | Silanol Density (Number |
|---|---|---|---|
| Type | Particle Size (nm) | Size(nm) | Per nm²) |
| A | 12 | 20 | 6.2 |
| B | 21 | 40 | 6.3 |
| C | 35 | 72 | 2.1 |

All of the abrasives A to C are colloidal silica, and all of them are surface-unmodified.

TABLE 2
Molybdenum SER Suppressor Types

| SER Suppressor | |
|---|---|
| Type | Chemical Name |
| A | disodium dodecyl(sulfonatophenoxy)benzenesulfonate |
| | (COMMON NAME: Disodium |
| | dodecyl(sulfophenoxy)benzenesulfonate) (CAS Number 28519-02-0) |
| | 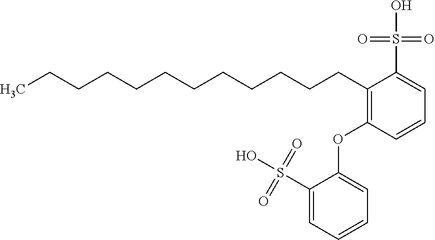 [SMILES: CCCCCCCCCCCCc1c(Oc2ccccc2S(=O)(=O)O)cccc1S(=O)(=O)O] |
| B | benzene, 1,1′-oxybis-, sec-hexyl derivs., sulfonated (acid form) |
| | (CAS Number 147732-59-0) |
| | 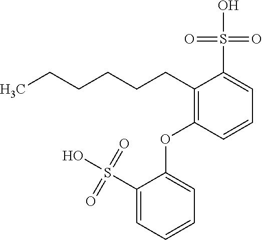 [SMILES: CCCCCCc1c(Oc2ccccc2S(=O)(=O)O)cccc1S(=O)(=O)O] |
| C | benzene, 1,1′-oxybis-, tetrapropylene derivs., sulfonated (acid form) (COMMON |
| | NAME: Tetrapropyl-(sulfophenoxy)-benzenesulfonic acid) (benzene, 1,1′-oxybis-, |
| | tetrapropylene derivs., sulfonated (acid form)) (CAS Number 119345-03-8) |
| | 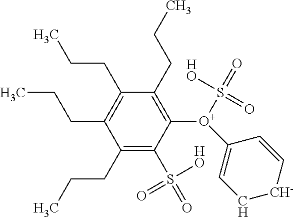 |
| D | lauryl sulfonic acid |
| E | capryleth-6 carboxylic acid |
| F | sulfonated acrylic polymer (MW 10,000) |
| G | polystyrenesulfonic acid, sodium salt (MW 10,000) |
| H | polyacrylic Acid (MW: 10,000) |
| I | polyalkylene glycol monobutyl ether |
| J | polyvinyl alcohol (PVA) |
| K | polyoxyethylene (10) oleyl ether phosphate |
| L | polyoxyethylene phenyl phosphate (8), K⁺ salt |
| M | polyoxyethylene (14) oleyl ether phosphate |
| N | polyoxyethylene (10) alkyl ether phosphate |
| O | phosphate ester, 4 EO groups, straight chain C12/C14, acid form |
| P | polyoxyethylene (8) tridecyl ether phosphate |
| Q | polyoxyethylene (12) tridecyl ether phosphate |
| R | polyoxyethylene (10) tridecyl ether phosphate |
| S | L-arginine |
| T | L-histidine |
| U | L-lysine |
| V | aspartic acid |
| W | glutamic acid |

### Example 2. Effect of Oxidizers on Mo Removal Rate and Static Etch Rate

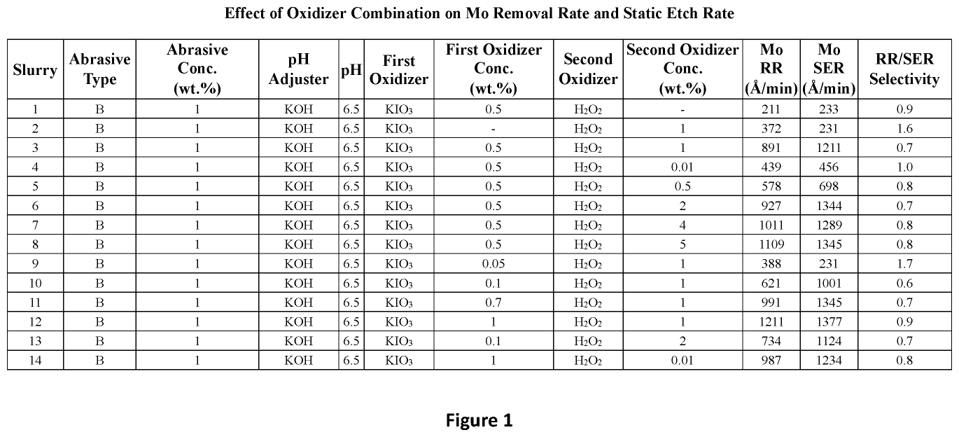

Mo substrates were polished using polishing compositions 1-14, each of which included 1 wt. % of abrasives (type B), with a polishing composition pH of 6.5 (using KOH as pH adjusting agent). Different concentrations of first and second oxidizers (KIO₃ and H₂O₂, respectively) were used to determine Mo RR, Mo SER, and RR/SER selectivity. The polishing performance is summarized in FIG. 1.

### Example 3. Effect of Molybdenum SER Suppressor

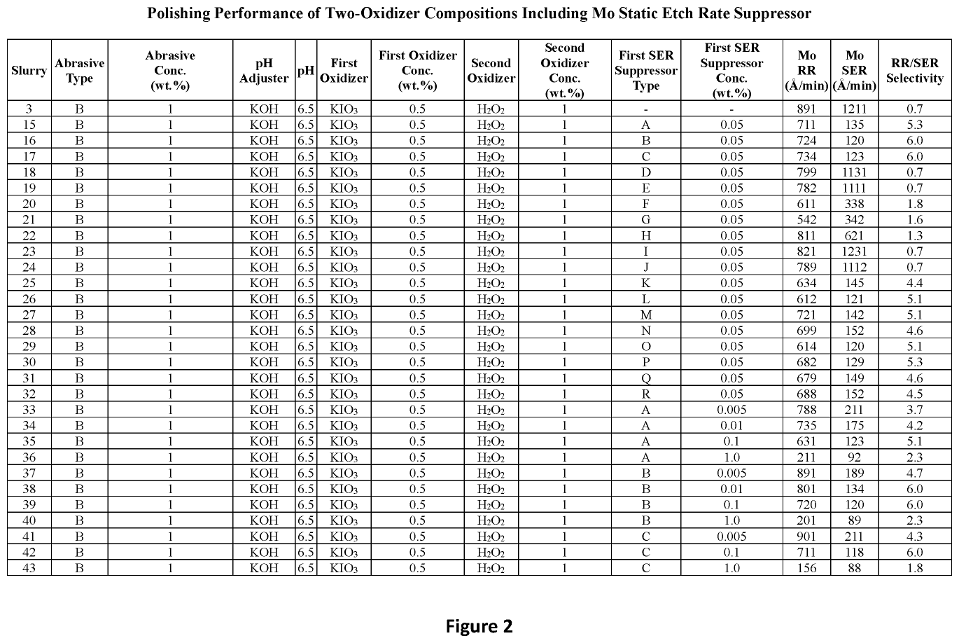

To test the polishing performance of compositions comprising a single Mo SER suppressor, Mo substrates were polished using polishing compositions 3 and 15-43, each of which included 1 wt. % of abrasives (type B), 0.5 wt. % of KIO₃ as the first oxidizer, and 1.0 wt. % of H₂O₂ as the second oxidizer, with a polishing composition pH of 6.5 (using KOH as pH adjusting agent). Various first Mo SER suppressors (A-R) were used at different concentrations to determine Mo RR, Mo SER, and RR/SER selectivity. The polishing performance is summarized in FIG. 2.

To test the polishing performance of compositions comprising two different Mo SER suppressors, Mo substrates were polished using polishing compositions 15 and 44-57, each of which included 1 wt. % of abrasives (type B), 0.5 wt. % of KIO₃ as the first oxidizer, and 1.0 wt. % of H₂O₂ as the second oxidizer, with a polishing composition pH of 6.5 (using KOH as pH adjusting agent). Various first Mo SER suppressors (A-C, P) and various second Mo SER suppressors (S-W) were used at different concentrations to determine Mo RR, Mo SER, and RR/SER selectivity. The polishing performance is summarized in Table 5.

TABLE 5
Polishing Performance of Polishing Compositions
Including 2 Oxidizers & 2 Mo SER Suppressors

| | | First SER | | Second SER | | | |
|---|---|---|---|---|---|---|---|
| | First SER | Suppressor | Second SER | Suppressor | Mo | Mo | |
| | Suppressor | Conc. | Suppressor | Conc. | RR | SER | RR/SER |
| Slurry | Type | (wt. %) | Type | (wt. %) | (Å/min) | (Å/min) | Selectivity |
| 15 | A | 0.05 | — | — | 711 | 135 | 5.3 |
| 44 | A | 0.05 | S | 0.05 | 688 | 67 | 10.3 |
| 45 | A | 0.05 | T | 0.05 | 689 | 69 | 10.0 |
| 46 | A | 0.05 | U | 0.05 | 634 | 72 | 8.8 |
| 47 | A | 0.05 | V | 0.05 | 736 | 110 | 6.7 |
| 48 | A | 0.05 | W | 0.05 | 721 | 109 | 6.6 |
| 49 | B | 0.05 | S | 0.05 | 690 | 66 | 10.5 |
| 50 | C | 0.05 | S | 0.05 | 685 | 67 | 10.2 |
| 51 | A | 0.01 | S | 0.01 | 755 | 111 | 6.8 |
| 52 | A | 0.05 | S | 0.01 | 699 | 87 | 8.0 |
| 53 | A | 0.05 | S | 0.7 | 671 | 65 | 10.3 |
| 54 | A | 0.5 | S | 0.7 | 611 | 94 | 6.5 |
| 55 | P | 0.05 | S | 0.05 | 672 | 71 | 9.5 |
| 56 | — | — | S | 0.05 | 699 | 452 | 1.5 |
| 57 | — | — | S | 0.5 | 211 | 246 | 0.9 |

### Example 4. Effect of Composition pH on Mo Removal Rate and Static Etch Rate

To test the polishing performance as a function of composition pH, Mo substrates were polished using polishing compositions 58-63, each of which included 1 wt. % of abrasives (type B), 0.5 wt. % of KIO₃ as the first oxidizer, 1.0 wt. % of H₂O₂ as the second oxidizer, 0.05 wt. % of suppressor A, and 0.05 wt. % l-arginine (suppressor S). The composition pH was adjusted using phosphoric acid (Examples 58-60) or KOH (61-63) to produce acidic and basic polishing compositions, respectively. The polishing performance is summarized in Table 6.

TABLE 6
Polishing Performance of Polishing
Compositions at Varied pH Values

| | | | Mo | Mo | |
|---|---|---|---|---|---|
| | | | RR | SER | RR/SER |
| Slurry | pH Adjuster | pH | (Å/min) | (Å/min) | Selectivity |
| 58 | phosphoric acid | 2 | 1244 | 452 | 2.8 |
| 59 | phosphoric acid | 3 | 1011 | 462 | 2.2 |
| 60 | phosphoric acid | 4 | 732 | 98 | 7.5 |
| 61 | KOH | 6.5 | 688 | 67 | 10.3 |
| 62 | KOH | 9 | 685 | 68 | 10.1 |
| 63 | KOH | 10 | 322 | 122 | 2.6 |

### Example 5. Effect of Abrasive Type on Mo Removal Rate and Static Etch Rate

To test the polishing performance as a function of abrasive type and concentration, Mo substrates were polished using polishing compositions 44 and 64-67, each of which included 0.5 wt. % of KIO₃ as the first oxidizer, 1.0 wt. % of H₂O₂ as the second oxidizer, 0.05 wt. % of suppressor A, and 0.05 wt. % l-arginine (suppressor S) and had a composition pH of 6.5 (using KOH as the pH adjusting agent). The polishing performance is summarized in Table 7.

TABLE 7
Polishing Performance of Polishing Compositions
Including Varied Abrasives

| | | | Mo | Mo | |
|---|---|---|---|---|---|
| | Abrasive | Abrasive Conc. | RR | SER | RR/SER |
| Slurry | Type | (wt. %) | (Å/min) | (Å/min) | Selectivity |
| 44 | B | 1.0 | 688 | 67 | 10.3 |
| 64 | A | 1.0 | 611 | 67 | 9.1 |
| 65 | B | 0.2 | 555 | 67 | 8.3 |
| 66 | C | 1.0 | 744 | 67 | 11.1 |
| 67 | B | 3.0 | 692 | 67 | 10.3 |

While certain embodiments have been illustrated and described, it should be understood that changes and modifications may be made therein in accordance with ordinary skill in the art without departing from the technology in its broader aspects as defined in the following claims.

The compositions and methods illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof. It is recognized that various modifications are possible within the scope of the disclosure claimed. Thus, it should be understood that although the present disclosure has been specifically disclosed by preferred embodiments and optional features, modification and variation of the disclosure embodied therein herein disclosed may be resorted to by those skilled in the art, and that such modifications and variations are considered to be within the scope of this disclosure.

The disclosure has been described broadly and generically herein. Each of the narrower species and subgeneric groupings falling within the generic disclosure also form part of the methods. This includes the generic description of the methods with a proviso or negative limitation removing any subject matter from the genus, regardless of whether or not the excised material is specifically recited herein. The present technology is not to be limited in terms of the particular embodiments described in this application, which are intended as single illustrations of individual aspects of the present technology. Many modifications and variations of this present technology can be made without departing from its spirit and scope, as will be apparent to those skilled in the art. Functionally equivalent methods and apparatuses within the scope of the present technology, in addition to those enumerated herein, will be apparent to those skilled in the art from the foregoing descriptions. Such modifications and variations are intended to fall within the scope of the present technology. It is to be understood that this present technology is not limited to particular methods, reagents, compounds compositions or biological systems, which can, of course, vary. It is also to be understood that the terminology used herein is for the purpose of describing particular embodiments only, and is not intended to be limiting.

One skilled in the art readily appreciates that the present disclosure is well adapted to carry out the objects and obtain the ends and advantages mentioned, as well as those inherent therein. Modifications therein and other uses will occur to those skilled in the art. These modifications are encompassed within the spirit of the disclosure and are defined by the scope of the claims, which set forth non-limiting embodiments of the disclosure.

In addition, where features or aspects of the disclosure are described in terms of Markush groups, those skilled in the art will recognize that the disclosure is also thereby described in terms of any individual member or subgroup of members of the Markush group.

All references, articles, publications, patents, patent publications, and patent applications cited herein are incorporated by reference in their entireties for all purposes. However, mention of any reference, article, publication, patent, patent publication, and patent application cited herein is not, and should not be taken as, an acknowledgment or any form of suggestion that they constitute valid prior art or form part of the common general knowledge in any country in the world.

Other embodiments are set forth in the following claims.

This application is based on U.S. Provisional Patent Application No. 63/449,831, filed on Mar. 3, 2023, the disclosure of which is incorporated herein by reference in its entirety.

What is claimed is:

1. A molybdenum polishing composition, comprising:
an abrasive;
a first molybdenum static etch rate suppressor;
a second molybdenum static etch rate suppressor;
a first oxidizer; and
a second oxidizer, wherein the polishing composition has a pH of 4 to 9.

2. The composition of claim 1, wherein the abrasive comprises unmodified colloidal silica.

3. The composition of claim 1, wherein the first molybdenum static etch rate suppressor comprises an anionic surfactant having a sulfonic acid moiety (—SO₃), phosphoric acid moiety (—OPO₃), or a salt thereof.

4. The composition of claim 1, wherein the first molybdenum static etch rate suppressor has a diphenyl ether structure.

5. The composition of claim 4, wherein the first molybdenum static etch rate suppressor has two or more sulfonic acid moieties (—SO₃).

6. The composition of claim 3, wherein the first molybdenum static etch rate suppressor has an oxyalkylene structure and a phosphoric acid moiety (—OPO₃).

7. The composition of claim 1, wherein
the first molybdenum static etch rate suppressor comprises at least one selected from:
dodecyl(sulfonatophenoxy)benzenesulfonic acid or salts thereof;
benzene, 1,1′-oxybis-, sec-hexyl derivatives, sulfonated (acid type) or salts thereof;
benzene, 1,1′-oxybis-, tetrapropylene derivatives, sulfonated (acid type) or salts thereof;
polyoxyethylene (10) oleyl ether phosphate;
polyoxyethylene (8) phenyl phosphate;
polyoxyethylene (14) oleyl ether phosphate;
polyoxyethylene (10) alkyl ether phosphate;
polyoxyethylene (8) tridecyl ether phosphate;
polyoxyethylene (10) tridecyl ether phosphate;
polyoxyethylene (12) tridecyl ether phosphate; and
salts thereof.

8. The composition of claim 1, wherein the second molybdenum static etch rate suppressor comprises an amino acid.

9. The composition of claim 8, wherein the second molybdenum static etch rate suppressor comprises a basic amino acid.

10. The composition of claim 1, wherein the first molybdenum static etch rate suppressor has a diphenyl ether structure and the second molybdenum static etch rate suppressor comprises a basic amino acid.

11. The composition of claim 1, wherein the first oxidizer comprises a halogen atom.

12. The composition of claim 11, wherein the first oxidizer comprises potassium iodate.

13. The composition of claim 12, wherein the second oxidizer comprises hydrogen peroxide.

14. The composition of claim 1, wherein a silanol group density of the abrasive is 2.0/nm² or more.

15. The composition of claim 1, wherein
the abrasive comprises unmodified colloidal silica,
the abrasive has the silanol group density of 2.0/nm² or more,
the first molybdenum static etch rate suppressor has, in one molecule,
a diphenyl ether structure and one or more sulfonic acid moieties (—SO₃) or
an oxyalkylene structure and a phosphoric acid moiety (—OPO₃),
the second molybdenum static etch rate suppressor comprises a basic amino acid,
the first oxidizer comprises potassium iodate, and
the second oxidizer comprises hydrogen peroxide.

16. The composition of claim 15, wherein the total concentration of the first molybdenum static etch rate suppressor and the second molybdenum static etch rate suppressor is about 0.03 wt. % to about 1.0 wt. %.

17. The composition of claim 1, wherein the composition has a ratio of molybdenum removal rate to molybdenum static etch rate greater than 6.0.
